(19) United States
(12) Patent Application Publication
(10) Pub. No.: US 2026/0218064 A1
(43) Pub. Date: Jul. 30, 2026

(54) LOW TEMPERATURE STABILIZATION OF LIQUID OILS

(71) Applicant: TOPSOE A/S, Kgs. Lyngby (DK)

(72) Inventors: Christian Ejersbo STREBEL, Kgs. Lyngby (DK); David Norman MCCARTHY, Kgs. Lyngby (DK); Magnus Zingler STUMMANN, Kgs. Lyngby (DK); Lived Yegres LEMUS-OLSEN, Kgs. Lyngby (DK)

(73) Assignee: TOPSOE A/S, Kgs. Lyngby (DK)

(21) Appl. No.: 19/148,820

(22) PCT Filed: Dec. 20, 2023
(86) PCT No.: PCT/EP2023/086802

§ 371 Date: Jul. 17, 2025

(30) Foreign Application Priority Data
Feb. 8, 2023 (EP) 23155600.2

(51) Int. Cl. C10G 45/06; B01J 8/02; B01J 21/04; B01J 23/755; B01J 35/30; B01J 35/61; B01J 35/63; B01J 37/16; C10G 1/00; C10G 1/02; C10G 65/04

(52) U.S. Cl. CPC C10G 45/06; B01J 8/0278; B01J 21/04; B01J 23/755; B01J 35/394; B01J 35/613; B01J 35/615; B01J 35/635; B01J 35/638; B01J 37/16; C10G 1/002; C10G 1/02; C10G 65/04; C10G 2300/1003; C10G 2300/202

(57) ABSTRACT

The invention relates to a process and plant for hydrotreating a liquid oil stream such as pyrolysis oil stream by, in continuous operation in a fixed bed reactor, reacting the liquid oil stream with hydrogen in the presence of a reduced nickel (Ni) catalyst at a temperature of 80-250° C., a pressure of 10-200 barg, a liquid hourly space velocity (LHSV) of 0.1-6.0 h⁻¹, and a hydrogen to liquid oil ratio, defined as the volume ratio of hydrogen to the flow of the liquid oil stream, of 100-8000 NL/L, thereby forming a stabilized liquid oil stream.

The invention relates to the field of hydroprocessing of liquid oils such as pyrolysis oils, more specifically to the stabilization of the liquid oil by hydrotreating prior to being upgraded by further hydroprocessing, such as hydrodeoxygenation (HDO). More particularly, the invention relates to the stabilization of liquid oils derived from the pyrolysis or hydrothermal liquefaction (HTL) of a solid renewable feedstock.

The field of renewable feedstocks has been attracting a great deal of attention worldwide. Using renewable feedstocks enables a sustainable approach to the production of hydrocarbon products boiling in the transportation fuel range, in particular any of diesel, jet fuel, suitably as sustainable aviation fuel (SAF), naphtha and gasoline; as well as hydrocarbon feeds such as naphtha, ethane, propane or butane, for steam crackers for polymer production.

The hydroprocessing of renewable feedstocks is a challenging task due to the variety and complexity of these feedstocks. Currently, it is normally perceived that there are three generations of renewable feedstocks. The first generation renewable feedstocks are renewable feedstocks which are already liquid and include virgin oils, such as rapeseed oil and soybean oil. The second generation renewable feedstocks are waste oil and fats, such as used cooking oils, animal fats and crude tall oil (CTO). The third generation of renewable feedstocks is much larger in volume, i.e. it is more available, than for instance the second generation. This third generation includes solid renewable feedstocks which encompasses: i) solid waste, such as agricultural residue and forestry residue, for instance lignocellulosic biomass such as grass; municipal waste, such as (unsorted) plastic waste; waste tyres; and ii) low indirect land-use change (ILUC) crops such as castor, which offer the benefit of not competing for space with food crops and can be grown in difficult climate. While the solid renewable feedstocks are cheaper to source and available in far greater volumes than first and second-generation feedstocks, there are still a number of challenges associated with such third-generation feedstocks.

Due to the Renewable Energy Directive II (RED II) under the European Union, a higher demand is expected for the hydroprocessing of advanced renewable feedstocks, such as pyrolysis oils derived from solid renewable feedstocks. The pyrolysis oil may have a very high oxygen content, which needs to be decreased before it can be used as liquid fuel, i.e. as hydrocarbon fuel boiling in the transportation fuel range. The oxygen of hydrocarbon feeds is generally removed by hydroprocessing in a catalytic hydrodeoxygenation (HDO) using high pressure (100-200 bar) and high temperature (350-400° C.). However, a liquid oil such as pyrolysis oil or a hydrothermal liquefaction oil, hereinafter also referred to as HTL oil, despite the HTL oil typically having a lower oxygen content than a pyrolysis oil, are very unstable and when heated it tends to polymerize, which leads to rapid catalyst deactivation and plugging of the HDO reactor, due to coking.

The liquid oils, these suitably being said pyrolysis oils or HTL oils, may present a wide range of oxygen (O) content, depending on the source, i.e. the solid renewable feedstock, and the thermal decomposition utilized for generation of the liquid oil. For instance, a liquid oil produced from a feedstock of plastic or polymer origin, which herein is also referred to as “waste plastic or polymer”, may contain 0.05-15 wt % O (500 ppm wt to 15 wt %), while a liquid feedstock originated from e.g. a lignocellulosic biomass or a sewage sludge may contain 30-50 wt % O. The liquid oil produced from a feedstock of plastic or polymer origin is also referred to as waste plastic pyrolysis oil (WPPO).

It would be desirable to upgrade the liquid oil, also in some instances referred to as biocrude, to valuable hydrocarbon fuels, such as jet fuel as sustainable aviation fuel (SAF), as well as renewable diesel, renewable naphtha and renewable gasoline, optionally also renewable maritime (marine) fuel, yet the liquid oil creates significant technical and economic challenges due to i.a.: low miscibility with other oils such as petroleum fractions, low thermal and oxidation stability such as instability at room conditions, high acidity and corrosiveness, polymerization tendency with increasing temperature, and coking.

It would thus be desirable to provide a process and plant that overcomes the above challenges and is superior than prior art approaches.

U.S. Pat. No. 3,691,066 A discloses the selective hydrogenation of unsaturated gasolines over a supported nickel catalyst at conditions including temperatures in the range 50-250° C. The total sulphur (S) content of the feedstock is 0.01-1.5 wt % with such feedstocks being produced by the thermal cracking of high sulphur content high boiling petroleum fractions.

EP 2707460 A1 discloses a process for stabilizing pyrolysis oil which includes hydrogenating a pyrolysis oil in the presence of a ruthenium metal catalyst at a temperature of at least about 70° C. and at a pressure of at least about 600 psig (about 40 barg) to form a hydrogenated a pyrolysis oil exhibiting an increase in viscosity of less than 10 percent.

WO 2022063597, WO 2022023263, WO 2022023262, WO 2022144235, and WO 2021110395 disclose methods for processing pyrolysis oils from plastics including selective hydrogenation.

US 20014/0275666 A1 discloses a process for treating bio-oil or pyrolysis oil in a two-stage process. The problem of plugging is addressed by providing a fractionation unit (distillation, FIG. 4) upstream the fixed-bed “stabilization” (1st stage). Further, experiments A-C, Table II therein, show the treatment of a feed with a NiMo catalyst in a fixed bed reactor.

Applicant's WO 2022152900 A1 discloses the stabilization of liquid oils with a NiMo catalyst.

It has been found that a process and plant comprising the provision of a reduced nickel (Ni) catalyst is capable of effectively stabilizing a wide range of liquid oils at low temperatures, i.e. in the range 80-250° C., including liquid oils with a low oxygen content (O) of 0.05-15 wt %, e.g. some waste plastic pyrolysis oils or some HTL oils, and liquid oils with a high oxygen content (O) of 30-50 wt %, such as 40-50 wt %, e.g. some pyrolysis oils from the pyrolysis of a lignocellulosic biomass feedstock or sewage sludge.

Accordingly, in a first aspect, as recited in appended claim 1, the invention provides a process for hydrotreating a liquid oil stream by, in a continuous operation in a fixed bed reactor, reacting the liquid oil stream with hydrogen in the presence of a reduced nickel (Ni) catalyst at a temperature of 80-250° C., a pressure of 10-200 barg, a liquid hourly space velocity (LHSV) of 0.1-6.0 h⁻¹, and a hydrogen to liquid oil ratio, defined as the volume ratio of hydrogen to the flow of the liquid oil stream, of 100-8000 NL/L, thereby forming a stabilized liquid oil stream; wherein the reduced Ni catalyst is a supported catalyst having a Ni content of 2-30 wt %, such as 5-25 wt %, based on the total weight of the catalyst; and the support is selected from any of: alumina (Al₂O₃), alumina magnesium spinel (MgAl₂O₄), and combinations thereof; optionally in combination with a molecular sieve having topology MFI, BEA or FAU; and wherein said alumina is any of:
alumina comprising 90-100 wt % gamma alumina; as well as having: a BET surface area of 230-250 m²/g, a total pore volume (PV) of 800-900 mL/kg as measured by mercury intrusion porosimetry;
alumina comprising 90-100 wt % gamma alumina; as well as having: a BET surface area of 165-185 m²/g, a total pore volume (PV) of 950-1100 mL/kg as measured by mercury intrusion porosimetry;
alumina comprising 80-100 wt % theta alumina and 0-20 wt % alpha alumina; as well as having: a BET surface area of 50-60 m²/g, a total pore volume (PV) of 600-700 mL/kg as measured by mercury intrusion porosimetry.

It would be understood that the unit “barg” denotes pressure above atmospheric (atmospheric pressure: about 1 bar). The pressure is also referred to as “hydrogen pressure”.

The term “first aspect” or “first aspect of the invention” means the process according to the invention. The term “second aspect” or “second aspect of the invention” means the plant, i.e. process plant (system), according to the invention.

The term “comprising” includes “comprising only”, i.e. “consisting of”.

The term “suitably” means “optionally”, i.e. an optional embodiment.

The term “present invention” or simply “invention” may be used interchangeably with the term “present application” or simply “application”.

The term “and/or” means in connection with a given embodiment any of three options.

The term “and/or” may be used interchangeably with the term “at least one of” the three options.

The use of the article “a” or “an” means at least one.

The term “reduced Ni catalyst” may be used interchangeably with the term “monometallic catalyst (Ni)” or “monometallic Ni catalyst”, Other definitions are provided in connection with one or more of the embodiments below.

In an embodiment, as recited in appended claim 2, the Ni content is 10-15 wt % and the alumina is said alumina comprising 90-100 wt % gamma alumina, such as 95-100 wt % gamma alumina, as well as having: a BET surface area of 165-185 m²/g, and a total pore volume (PV) of 950-1100 mL/kg as measured by mercury intrusion porosimetry.

The associated benefits are recited farther below.

By the present invention, a liquid oil having a high oxygen content of 30-50 wt %, e.g. a pyrolysis oil, is stabilized at said low temperatures by the conversion of at least the most reactive compounds in the pyrolysis oil, such as furfural, furans, aldehydes, ketones and acids, into alcohols, for instance by efficiently converting carbonyls into alcohols. The alcohols can further be converted to saturated organic compounds during the stabilization, and/or in a subsequent hydroprocessing stage such as hydrodeoxygenation (HDO). Also, by the present invention, a liquid oil having a low oxygen content of 0.05-15 wt %, e.g. a HTL oil, a waste plastic pyrolysis oil, or a waste tyre pyrolysis oil, is stabilized at said low temperatures by the conversion of at least the most reactive compounds in the HTL oil, such as dienes (di-olefins), more specifically conjugated di-olefins, for instance also by the conversion of styrene into ethylbenzene. Hence, the invention enables the stabilization of pyrolysis oils by converting i.a. carbonyls into alcohols, thus by mainly breaking C═O bonds; and/or the stabilization of HTL oils, waste plastic pyrolysis oils, or waste tyres pyrolysis oil, by i.a. converting styrene into ethylbenzene, thus by mainly breaking C═C bonds. Thereby, there is an increase in operation time before plugging issues—if any—arise, while at the same time suppressing coking of the catalyst and attendant catalyst deactivation, as well as avoiding hydrogen starvation.

The term “liquid oil” or “liquid oil stream” thus relates to a feedstock comprising compounds which at above temperatures (80-250° C.) but below the temperatures resulting in substantially complete hydrotreatment and which may react to form larger molecules, potentially resulting in full or partial blockage of reactors, tubes, heaters, heat exchangers and catalysts. Examples of such mixtures may be feedstock rich in said conjugated diolefins or styrene and its homologs from thermochemical decomposition of plastic waste, municipal solid waste, refuse derived fuel and solid recovered fuel, feedstock rich in carbonyls and sugars from thermochemical decomposition of lignocellulosic biomass and feedstock rich in nitrogen from thermochemical decomposition of nitrogen rich biomass, such as manure and sewage sludge, and similar composition from other sources. The reactive compounds may either react within the same functional group (for example, diolefin with diolefin) or across functional groups (for example, aldehyde with phenol).

The temperature range 80-250° C. encompasses the inlet temperature of the liquid oil stream and the outlet temperature of stabilized liquid oil stream. For instance, the inlet temperature can be 80, 90, 100, 110, 120° C. The process is exothermic, thus a rise in temperature of about 100° C. or more may occur. The higher the inlet temperature, the easier the ignition of the process to initiate the exotherm. The outlet temperature can for instance be 150, 160, 200 or 240° C. More generally, the temperature in a given step or reactor (unit) thereof, means the inlet temperature in an adiabatic step, or the reaction temperature in an isothermal step.

The term continuous operation, as is well known in the art, means that the incoming stream of liquid oil during a given production cycle is constant, as also is the stabilized liquid oil stream being withdrawn as the outcoming product. This contrasts a batch operation i.e. discontinuous operation, as is also well known in the art, in which the total amount of liquid oil and catalyst is introduced at the beginning of the process, and the outcoming product is withdrawn after a certain period of time.

By the present invention, a continuous operation process is used, since contrary to a batch operation, there is no dependency on the outcoming product (stabilized liquid oil) being fluid at all times. In a batch operation the liquid oil could start fluid, then solidify for a period during a first temperature and then become fluid again when heated to the final higher temperature. Furthermore, a batch operation gives only an idea about the initial catalyst activity, thus it can easily overestimate the catalyst activity, which is also crucial for industrial application.

Moreover, there is a large difference between operating with an outlet temperature above 250° C., such as 340° C. or higher, as in the prior art such as in conventional hydrodeoxygenation, and 250° C. or lower, for instance 200° C., as in the present invention. For instance, at ~200° C. carbonyls are converted to alcohols as it will also become apparent from discussion below. Some sugars may also be converted to diols and dehydrate some of the alcohols. On the other hand, at around 340° C. phenols will start to be removed and depending on the pressure and LHSV, the oxygen in the liquid oil may also be removed.

By the invention, the process is also conducted at a hydrogen to liquid oil ratio of 100-8000 NL/L, such as 200, 300, 400, 500, 600, 700, 800, 900, 1000, 1500, 2000, 2500, 3000, 3500, 4000, 4500, 5000, 5500, 6000, 6500, 7000 or 7500 NL/L. As used herein, the term “hydrogen to liquid oil ratio” or “H₂/oil ratio” means the volume ratio of hydrogen to the flow of the liquid oil stream. The volume of liquid oil is in line with the practice in the field determined at 15° C. and 1 atmosphere. It would be understood that the unit NL means “normal” liter, i.e. the amount of gas taken up this volume at 0° C. and 1 atmosphere.

In order to stabilize pyrolysis oil, the hydrogen consumption usually, as measured by the H₂/oil ratio, is between 100-350 NL/L, yet in order to avoid hydrogen starvation we have found that the H₂/oil ratio should be higher, i.e. 100-8000 NL/L, such as 400-6000 NL/L, for instance 400-600 NL/L, or 400-700 NL/L, such as 500-600 NL/L, for a liquid oil with low oxygen (O) content such as a HTL oil, or 1500-5000 NL/L for a liquid oil with high oxygen content such as a pyrolysis oil. Since the stabilized liquid oil is suitably sent directly to a HDO reactor, as it will become apparent from a below embodiment, and the hydrogen consumption generally would be between 400-800 NL/L, we have found that for a pyrolysis oil it is even more preferable that the H₂/oil ratio is between e.g. 1500 and 5000 NL/L in order to avoid hydrogen starvation. For instance, 100-350 NL/L is needed to stabilize the liquid oil and 400-800 NL/L to deoxygenate it, thus the total hydrogen consumption for this particular instance can be as high as 1150 NL/L. Adding H₂ in excess of this amount, e.g. 1500-3500, such as 200-3000 NL/L pushes the reaction rate and/or equilibrium.

Hence, by the present invention, said low temperature (80-250° C. e.g. 100-240° C.) stabilization of a liquid oil is possible. Furthermore, by the present invention, not only stabilization of the liquid oil is possible thereby avoiding the plugging problems described above, but also stabilization without deactivating the catalyst and without risk of hydrogen starvation.

In an embodiment, as recited in appended claim 3, the liquid oil stream contains at least 0.05 wt % oxygen (O), such as at least 0.1 wt % O, at least 0.5 wt % oxygen (O), at least 1 wt % O, at least 5 wt % O, at least 10 wt % O, at least 15 wt % O, at least 20 wt % O, at least 25 wt % O, at least 30 wt % O, at least 35 wt % O, at least 40 wt % O, or at least 45 wt % O; for instance 0.05-50 wt % O, such as 0.05-15 wt % 0, 30-50 wt % or 40-50 wt % O. The oxygen is suitably determined by standard elemental analysis.

Hence, in an embodiment, the liquid oil stream contains at least 20 wt % oxygen (O), such as at least 30 wt % O, or at least 45 wt % O. This oxygen content is representative of particularly reactive liquid oil feeds, as the content of oxygen may serve as a proxy of how reactive the liquid oil is. Thus, a highly reactive liquid oil stream may contain as much as 45 wt % oxygen or even higher; for instance, a highly reactive liquid oil stream may contain 30-50 wt % O, such as 40-50 wt % O. For the purposes of the present application, a liquid oil having this content of oxygen (30-50 wt %) is regarded as a highly reactive liquid oil stream, in particular a highly reactive pyrolysis oil stream. In another embodiment, the liquid oil stream 0.05-15 wt % O. This is a less reactive liquid oil stream, yet still requiring stabilization. For the purposes of the present application, a liquid oil having this content of oxygen is regarded as a less reactive liquid oil stream, in particular a less reactive HTL oil stream, or a less reactive pyrolysis oil stream. For instance, a waste plastic pyrolysis oil may contain as low as 500 ppm wt (0.05 wt %) oxygen, and a waste tyre pyrolysis oil may contain 0.1-5 wt % oxygen. Liquid oils with intermediate oxygen content, such as in between 15 and 30 wt % oxygen, excluding the end points, is for the purposes of the present application regarded as an intermediate reactive liquid oil stream, which can be any of a HTL oil stream, pyrolysis oil stream, and combinations thereof.

In an embodiment, as recited in appended claim 4, the ratio of the carbonyl number as measured by ASTM E 3146 in mol/kg of the liquid oil stream with respect to the stabilized liquid oil stream, i.e. carbonyl number ratio, is 1.7 or higher, such as 2 or higher, for instance 3 or higher.

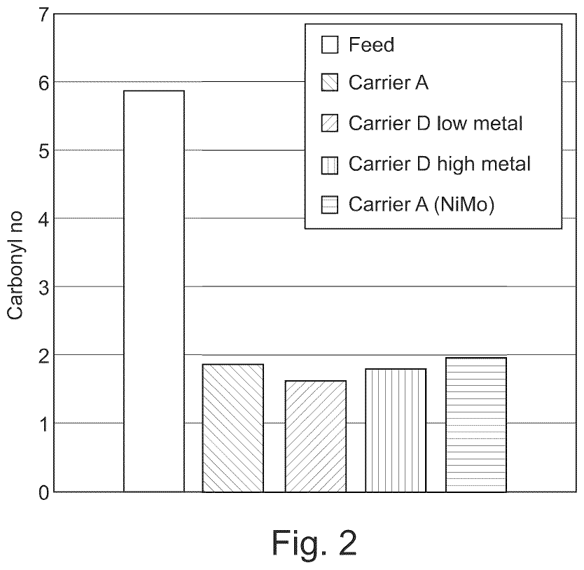

It has been found that for a carbonyl number ratio of 1.7 or higher, such as 2 or higher, for instance 3 or higher, the plugging of a subsequent HDO reactor is avoided. The higher the carbonyl number ratio, the more efficient is the process in breaking C═O bonds and the more efficient the stabilization, in particular when operating with highly reactive liquid oils, thus rendering a stabilized liquid oil stream which is much less reactive than the highly reactive liquid oil stream being fed to the process. It has been found that with the present invention, which includes the provision of a reduced nickel (Ni) catalyst, i.e. a monometallic catalyst (Ni), the carbonyl number ratio is higher than when a NiMo catalyst is utilized. A superior process is thus provided by the present invention, as for instance shown in appended FIG. 2.

In an embodiment, as recited in appended claim 5, the carbonyl number of the stabilized liquid oil stream is below 3.0 mol/kg, such as between 1.0 and 2.0 mol/kg, as measured by ASTM E 3146.

Compared to a stabilization comprising the use of a NiMo-based catalyst, the carbonyl number ratio of the present invention is higher. Accordingly, the carbonyl number of the stabilized liquid oil stream is also lower, for instance said 1.0-2.0 mol/kg, such as 1.5-1.9 mol/kg, e.g. 1.6, 1.7, or 1.8 mol/kg. See appended FIG. 2.

The process may be operated by controlling the carbonyl number in the stabilization reactor, so it is maintained below 3.0 mol/kg, for instance between 1.0 and 2.0 mol/kg, since it has been found that increasing the carbonyl number to 3.0 or higher may cause coking and thus plugging of a downstream HDO unit (reactor). Suitably also the carbonyl number ratio is monitored so that it is 1.7 or higher at any time, to avoid coking and thus plugging of a downstream HDO reactor.

As recited above, in an embodiment, the liquid oil stream is a pyrolysis oil stream or a hydrothermal liquefaction oil (HTL oil) stream.

In an embodiment the liquid oil stream is a pyrolysis oil stream which comprises at least 0.5 mol/kg of one or more of: aldehyde compounds, ketones, alcohols, furfural, as determined by ASTM E3146-20.

The invention comprises that the reduced Ni catalyst is a supported catalyst having a Ni content of 2-30 wt %, such as 5-25 wt %, based on the total weight of the catalyst, and the support is selected from any of: alumina (Al₂O₃), alumina magnesium spinel (MgAl₂O₄), and combinations thereof; optionally in combination with a molecular sieve having topology MFI, BEA or FAU.

A catalyst with this composition is suitable for the stabilization of less reactive, intermediate and highly reactive liquid oils, thus for a wide range of liquid oils containing 0.05-50 wt % oxygen. The invention thus advantageously provides flexibility with respect to the liquid oil stream, i.e. the liquid oil feed, being stabilized. There is no need to for instance change the catalyst when the liquid oil feed is a less reactive liquid oil stream, or a highly reactive liquid oil stream.

In an embodiment, said Ni content is any of 2, 3, 4, 5, 6, 7, 8, 9, 10, 11, 12, 13, 14, 15, 16, 17, 18, 19, 20, 21, 22, 23, 24, 25, 26, 27, 28, 29, 30 wt % based on the total weight of the catalyst, and the support is selected from any of: alumina (Al₂O₃), alumina magnesium spinel (MgAl₂O₄), and combinations thereof; optionally in combination with a molecular sieve having topology MFI, BEA or FAU.

The invention comprises that said alumina is any of:
alumina comprising 90-100 wt % gamma alumina, such as 95-100 wt % gamma alumina; as well as having:
   a BET surface area of 230-250 m²/g,
   a total pore volume (PV) of 800-900 mL/kg as measured by mercury intrusion porosimetry;
alumina comprising 95-100 wt % gamma alumina, such as 95-100 wt % gamma alumina; as well as having:
   a BET surface area of 165-185 m²/g,
   a total pore volume (PV) of 950-1100 mL/kg as measured by mercury intrusion porosimetry;
alumina comprising 80-100 wt % theta alumina and 0-20 wt % alpha alumina; as well as having:
   a BET surface area of 50-60 m²/g,
   a total pore volume (PV) of 600-700 mL/kg as measured by mercury intrusion porosimetry.

The mercury intrusion porosimetry is conducted according to ASTM D4284. Hence, for determination of total pore volume and pore size distribution, mercury intrusion porosimetry is measured according to ASTM D4284. The BET-surface area is measured according to ASTM D4567-19, i.e. single-point determination of surface area by the BET equation. The content of alpha alumina, theta alumina, gamma alumina is as determined by XRD (X-ray diffraction). More specifically, XRD for determination of e.g. alumina phases: samples are rinsed by extraction with xylene, dried in vacuum and analysed for metals/P capture (XRF, X-ray fluorescence analysis according to EN ISO 12677:2011), SEM, Carbon and Sulphur (C+S; LECO analysis, ASTM E1915-13) and BET-surface area (ASTM D4567-19).

A catalyst with these specific alumina supports is particularly suitable for the stabilization of intermediate and even more so for highly reactive liquid oils containing at least 30 wt % oxygen, for instance at least at least 40 wt % or at least 45 wt % oxygen. For instance, another proxy for the degree of stabilization is the density of the liquid oil. The higher the density, the higher the viscosity. Hence, the lower the density of the stabilized liquid oil compared to the density of the liquid oil feed, the better the stabilization.

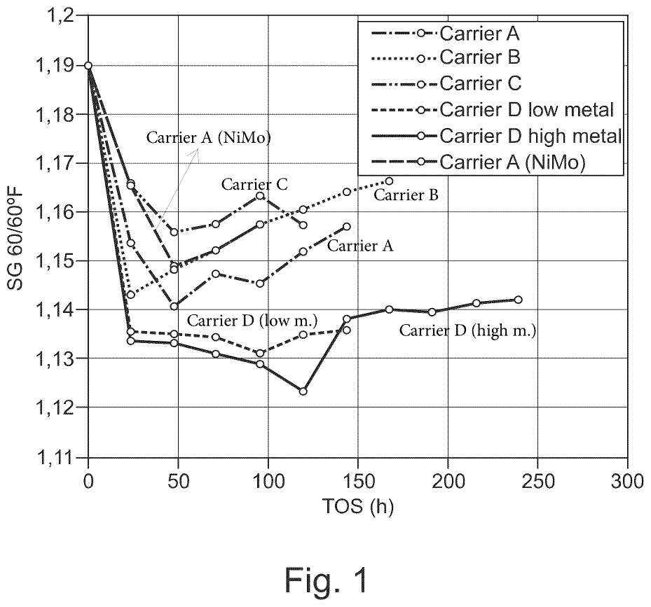

The invention enables the stabilization of a wide range of liquid oils from third generation renewable feedstocks generating liquid oil streams with low oxygen content such as 0.05-15 wt % O, and/or liquid oil streams with a high oxygen content such as 30-50 wt % O. For instance, for the latter, there is a significant decrease in the density of the liquid oil and a reduction in carbonyl number, as shown in appended FIGS. 1 and 2.

It has been found that it is possible to significantly reduce the density of the liquid oil being fed to the stabilization process, in particular with an alumina support having intermediate BET surface area and high pore volume, as recited in the following embodiment. Accordingly, in accordance with said appended claim 2, the Ni content is 10-15 wt % and the alumina is said alumina comprising 90-100 wt % gamma alumina, such as 95-100 wt % gamma alumina, as well as having: a BET surface area of 165-185 m²/g, and a total pore volume (PV) of 950-1100 mL/kg as measured by mercury intrusion porosimetry.

Even better results in terms of decreasing density, increasing carbonyl number ratio or decreasing the carbonyl number of the stabilized liquid oil are thereby obtained. As shown in appended FIG. 1, it is possible to even further reduce the density of the liquid oil being fed in the stabilization process. While some of the catalysts show a minimum in density after certain time on stream (TOS) for then increasing again in density up to a level below yet somewhat close to the density of the feed (density of feed: 1.19, cf. Y-axis of FIG. 2), the catalysts with relative lower Ni content of 10-15 wt % (D-low Ni, denoted in the figures as “Carrier D low metal”) or high Ni content of 20-25 wt % (D-high Ni, denoted in the figures as “Carrier D high metal”), 90-100 wt % gamma alumina having a BET surface area of 165-185 m²/g, and a total pore volume (PV) of 950-1100 mL/kg (shown as the two lower lines in FIG. 1), show a surprisingly low density which reaches a plateau at this level, i.e. it is maintained at a low density. Further, the carbonyl number (FIG. 2) is also the lowest. A superior performance compared to e.g. NiMo catalyst is thus obtained. A superior performance with respect to the other reduced Ni catalysts i.e. monometallic catalysts (Ni) is also obtained.

Hence, further, the performance of the D-low Ni catalyst (“Carrier D low metal”) in terms of density reduction of the liquid oil feed is at least on par with that obtained with the reduced nickel catalyst with the same alumina carrier but with almost twice as much nickel (D-high, i.e. “Carrier D high metal”); yet superior in terms of lower carbonyl number, despite its lower Ni content, as also shown in appended FIG. 2. The amount of metal required is thus reduced, also with respect to the combined metal content of a NiMo catalyst. This conveys a much more inexpensive operation of the stabilization reactor.

The support may comprise a molecular sieve having topology MFI, BEA or FAU. As used herein, the term “topology MFI, BEA or FAU”, means a structure as assigned and maintained by the International Zeolite Association Structure Commission in the Atlas of Zeolite Framework Types, which is at http://www.iza-structure.org/databases/ or for instance also as defined in “Atlas of Zeolite Framework Types”, by Ch. Baerlocher, L. B. McCusker and D. H. Olson, Sixth Revised Edition 2007.

In an embodiment, as recited in appended claim 6, the temperature is in the range 80-225° C., such as 100-225° C.; the pressure is 120-200 barg, such as 125-175 barg, e.g. 135-155 barg; LHSV is 0.1-1.0 h⁻¹, such as 0.2-0.6 h⁻¹; the hydrogen to liquid oil ratio is 1500-3500 NL/L such as 2000-3000 NL/L, and the liquid oil stream contains 30-50 wt % O. These process conditions are thus particularly advantageous for highly reactive pyrolysis oils. At these conditions, breaking of C═O bonds in the liquid oil is further ensured. Furthermore, as already explained, the particular range of hydrogen to liquid oil ratio has the associated benefit of hydrogen starvation being avoided as well as pushing the reaction rate and/or equilibrium.

In an embodiment, as recited in appended claim 7, the temperature is in the range 80-225° C., such as 100-200° C.; the pressure is 40-180 barg, such as 40-60 barg, e.g. 45-55 barg, or 70-180 barg such as 100-150 barg; LHSV is 1-3 h⁻¹, such as 1.5-2.5 h⁻¹; the hydrogen to liquid oil ratio is 400-700 NL/L such as 500-600 NL/L, and the liquid oil stream contains 0.05-15 wt % O. These process conditions are thus particularly advantageous for less reactive HTL oils, waste plastic pyrolysis oils or waste tyres pyrolysis oils. At these conditions, breaking of C═C bonds in the liquid oil is further ensured. The breakage of C═C bonds via the use of a reduced nickel catalyst in accordance with the present invention, as exemplified by the conversion of styrene to ethylbenzene, is significantly higher than when a NiMo-based catalyst is used. Furthermore, as already explained, the particular range of hydrogen to liquid oil ratio has the associated benefit of hydrogen starvation being avoided. The pressure is for instance 50, 60, 70, 80, 90, 100, 110, 120, 130, 140, 150, 160, or 170 barg. While for some pyrolysis oils, e.g. waste plastic pyrolysis oils, pressures in the rage 40-60 barg may suffice, for some HTL oils the pressure needed may be higher, thus suitably in the range 70-180 barg.

A stabilized liquid oil stream is thereby obtained, which enables stable long-term operation of subsequent upgrading steps and associated units, in particular hydrodeoxygenation (HDO), as it will also become apparent from a below embodiment.

In an embodiment, as recited in appended claim 8, the content of sulfur (S) in said liquid oil stream containing 0.05-15 wt % O, is below 100 ppm wt, such as 1-90 ppm wt, for instance 5, 10, 20, 30, 40, 50, 60, 70, 80 ppm wt.

Thereby, the Ni catalyst is surface-passivated with sulfur in the liquid oil stream by the formation of a protective oxide layer of sulfur on the active metal (Ni), which prevents its oxidation. The catalyst may thus be surface-passivated by exposure to the sulfur present in the liquid oil. While still in its reduced form, it has been found that a small amount of sulfur is in fact required to dampen the activity of the reduced Ni catalyst, and by consequence enhance its selectivity so at low temperatures only dienes (di-olefins) are hydrogenated and not also mono-olefins. Such passivation has been found to be particularly relevant for liquid oils produced from a feedstock of plastic or polymer origin; for such liquid oils, the surface-passivation is thus provided in-situ, i.e. during operation, as one may encounter therein sulfur contents below 100 ppm wt.

While it is known from e.g. the above-cited U.S. Pat. No. 3,691,066 that gasoline produced from a fossil source and having a high sulfur content (0.01-1.5 wt % sulfur) can be hydrogenated over a nickel catalyst without significant sulfur poisoning, it is surprising that a small amount of sulfur does not impair the hydrogenation activity of the reduced Ni catalyst during the stabilization of the liquid oil derived from e.g. a feedstock of plastic or polymer origin according to the present invention. The provision of a sulfur removal unit or a sulfur removal guard prior to—thus upstream—the stabilization is thereby omitted. In addition, halogens in the liquid oil, particularly waste plastic pyrolysis oil, may content halogens such as Cl, whereby the expectation is such halogen inhibiting the hydrogenation activity due to e.g. NiCl₂ formation.

In an embodiment, as recited in appended claim 9, the process further comprises a prior step of thermal decomposition of a solid renewable feedstock, for producing said liquid oil stream; wherein said liquid oil stream is a pyrolysis oil stream or a hydrothermal liquefaction oil (HTL oil) stream; and wherein the thermal decomposition step is:
pyrolysis, such as fast pyrolysis, thereby producing said pyrolysis oil stream; or
hydrothermal liquefaction, thereby producing said HTL oil stream.

As used herein, the term “thermal decomposition” shall for convenience be used broadly for any decomposition process, in which a material is partially decomposed at elevated temperature (typically 250° C. to 800° C. or even 1000° C.), in the presence of substoichiometric amount of oxygen (including no oxygen). The product will typically be a combined liquid and gaseous stream, as well as an amount of solid char. The term shall be construed to include processes known as pyrolysis and hydrothermal liquefaction, both in the presence and absence of a catalyst.

Accordingly, in a particular embodiment, the thermal decomposition is pyrolysis, such as fast pyrolysis, as defined farther below, thereby producing said pyrolysis oil stream.

It would be understood that the thermal decomposition is conducted in a thermal decomposition section. Hence, the pyrolysis is conducted in a pyrolysis section, and the hydrothermal liquefaction is conducted in a hydrothermal liquefaction section.

As used herein, the term “section” means a physical section comprising a unit or combination of units for conducting one or more steps and/or sub-steps.

For the purposes of the present invention, the pyrolysis section generates two main streams, namely a pyrolysis off-gas stream and a pyrolysis oil stream. The pyrolysis section may be in the form of a fluidized bed, transported bed, or circulating fluid bed, as is well known in the art. For instance, the pyrolysis section may comprise a pyrolyser unit (pyrolysis reactor), cyclone(s) to remove particulate solids such as char, and a cooling unit for thereby producing said pyrolysis off-gas stream and said pyrolysis oil stream, i.e. condensed pyrolysis oil. The pyrolysis off-gas stream comprises light hydrocarbons e.g. C1-C4 hydrocarbons, CO and CO₂. The pyrolysis oil stream is also referred as bio-oil or bio-crude and is a liquid substance rich in blends of molecules usually consisting of more than two hundred different compounds including aldehydes, ketones and/or other compounds such as furfural having a carbonyl group, resulting from the depolymerisation of products treated in pyrolysis.

For the purposes of the present invention, the pyrolysis is preferably fast pyrolysis, also referred in the art as flash pyrolysis. Fast pyrolysis means the thermal decomposition of a solid renewable feedstock in the absence of oxygen, at temperatures in the range 350-650° C. e.g. about 500° C. and reaction times of 10 seconds or less, such as 5 seconds or less, e.g. about 2 sec. Fast pyrolysis may for instance be conducted by autothermal operation e.g. in a fluidized bed reactor. The latter is also referred to as autothermal pyrolysis and is characterized by employing air, optionally with an inert gas or recycle gas, as the fluidizing gas, or by using a mixture of air and inert gas or recycle gas. Thereby, the partial oxidation of pyrolysis compounds being produced in the pyrolysis reactor (autothermal reactor) provides the energy for pyrolysis while at the same time improving heat transfer. For details about autothermal pyrolysis, reference is given to e.g “Heterodoxy in Fast Pyrolysis of Biomass” by Robert Brown: https://dx.doi.org/10.1021/acs.energyfuels.0c03512

It would therefore be understood, that for the purposes of the present invention, the use of autothermal pyrolysis. i.e. autothermal operation, is a particular embodiment for conducting fast pyrolysis.

There are several types of fast pyrolysis where a catalyst is used. Sometimes an acid catalyst is used in the pyrolysis reactor to upgrade the pyrolysis vapors, this technology is called catalytic fast pyrolysis and can both be operated in an in-situ mode (the catalyst is located in the pyrolysis reactor) and an ex-situ mode (the catalyst is placed in a separate reactor). The use of a catalyst conveys the advantage of lowering the activation energy for reactions thereby significantly reducing the required temperature for conducting the pyrolysis. In addition, increased selectivity towards desired pyrolysis oil compounds may be achieved.

In some cases, hydrogen is added to the catalytic pyrolysis which is called reactive catalytic fast pyrolysis. If the catalytic pyrolysis is conducted at a high hydrogen pressure (~>5 barg) it is often called catalytic hydropyrolysis.

In an embodiment, as recited in appended claim 10, the pyrolysis stage is fast pyrolysis which is conducted without the presence of a catalyst and hydrogen, i.e. the fast pyrolysis stage is not catalytic fast pyrolysis, hydropyrolysis or catalytic hydropyrolysis. This enables a much simpler and inexpensive process.

In an embodiment, said pyrolysis off-gas stream comprises CO, CO₂ and light hydrocarbons such as C1-C4, and optionally also H₂S.

In an embodiment, the thermal decomposition is hydrothermal liquefaction. Hydrothermal liquefaction means the thermochemical conversion of biomass into liquid fuels by processing in a hot, pressurized water environment for sufficient time to break down the solid polymeric or bio-polymeric structure to mainly liquid components. Typical hydrothermal processing conditions are temperatures in the range of 250-375° C. and operating pressures in the range of 40-220 bar. This technology offers the advantage of operation of a lower temperature, higher energy efficiency and lower tar yield compared to pyrolysis, e.g. fast pyrolysis. For details on hydrothermal liquefaction of biomass, reference is given to e.g. Golakota et al., “A review of hydrothermal liquefaction of biomass”, Renewable and Sustainable Energy Reviews, vol. 81, Part 1, January 2018, p. 1378-1392.

In an embodiment, the thermal decomposition is liquefaction. Liquefaction means the thermochemical conversion of biomass into liquid fuels by processing in the absence of water. Typical conditions are temperatures in the range of 250-375° C. and operating pressures in the range of 40-220 bar. For instance also, as described in WO21209555 A1.

In an embodiment, the thermal decomposition further comprises passing said solid renewable feedstock through a solid renewable feedstock preparation section comprising for instance drying for removing water and/or comminution for reduction of particle size. Any water/moisture in the solid renewable feedstock which vaporizes in for instance the pyrolysis section condenses in the pyrolysis oil stream and is thereby carried out in the process, which may be undesirable. Furthermore, the heat used for the vaporization of water withdraws heat which otherwise is necessary for the pyrolysis. By removing water and also providing a smaller particle size in the solid renewable feedstock the thermal efficiency of the pyrolysis section is increased.

In an embodiment, as recited in appended claim 11, the solid renewable feedstock is a lignocellulosic biomass including: wood products, forestry waste, and agricultural residue. In another embodiment, as also recited in appended claim 11, the solid renewable feedstock is sewage sludge, in particular the organic fraction thereof. In another embodiment, as also recited in appended claim 11, the solid renewable feedstock is waste tyres. In another embodiment, as also recited in appended claim 11, the solid renewable feedstock is municipal waste, in particular the organic portion thereof. In another embodiment, as also recited in appended claim 11, the solid renewable feedstock is a feedstock of plastic or polymeric origin, i.e. waste plastic or polymer, including a mixed or sorted waste comprising at least 50 wt %, 80 wt % or 90 wt % plastic and other synthetic polymers. Any combination of the above feedstocks is also envisaged.

For the purposes of the present application, the term “sewage sludge” means the residual, semi-solid material that is produced as a by-product during sewage treatment of industrial or municipal wastewater; for instance, a dewatered sludge comprising: 50-70 wt % organic matter and 30-50 wt % mineral components (including 1-4 wt % of inorganic carbon), 1-10 wt % N, e.g. 3.4-4.0 wt % nitrogen (N), 0.5-2.5 wt % phosphorus (P).

For the purposes of the present application, the term “municipal waste” is interchangeable with the term “municipal solid waste” and means a feedstock containing materials of items discarded by the public, such as mixed municipal waste given the waste code 200301 in the European Waste Catalog.

In a particular embodiment, the lignocellulosic biomass is forestry waste and/or agricultural residue and comprises biomass originating from plants including grass such as nature grass (grass originating from natural landscape), wheat e.g. wheat straw, oats, rye, reed grass, bamboo, sugar cane or sugar cane derivatives such as bagasse, maize and other cereals.

As used herein, the term “lignocellulosic biomass” means a biomass containing cellulose, hemicellulose and optionally also lignin. The lignin or a significant portion thereof may have been removed, for instance by a prior bleaching step.

In an embodiment, as recited in appended claim 12, the process further comprises passing the stabilized pyrolysis oil stream through a hydrodeoxygenation (HDO) step, suitably wherein the HDO is conducted at a higher temperature and equal or lower pressure than the prior step for forming said stabilized liquid oil stream.

Thereby, any organic nitrogen present in the stabilized pyrolysis oil stream is removed and a hydrotreated stream is produced, which can be further treated for producing hydrocarbon products boiling in the transportation fuel range, such as diesel, jet fuel (suitably as sustainable aviation fuel, SAF) and naphtha. The further treatment may include any of: hydrodewaxing isomerization, hydrocracking, as is well known in the art of fossil oil refining.

As mentioned before, renewable feedstocks including intermediate products thereof such as liquid oils e.g. pyrolysis oils, often contain a high amount of oxygen compounds and unsaturated hydrocarbons. During the hydrotreating of renewable feedstock or liquid oil, the oxygen is mainly removed as H₂O. This is called the hydrodeoxygenation (HDO) pathway. Oxygen can also be removed by dicarboxylic (DCO) pathway, which generates CO₂ instead of H₂O:

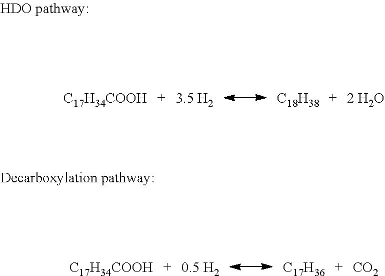

When stabilizing the liquid oil, alcohols and among other acids e.g. fatty acids therein, are converted: alcohols may be converted to their respective alkanes or unsaturated organic compounds and thereafter hydrogenated to the respective alkanes; acids and other compounds comprising a carbonyl group such as aldehydes and ketones are first converted by hydrogenation to their respective alcohols and these may later be converted to alkanes as explained above. In the stabilization, the oxygen atom in the carbonyl group of a given organic compound may be removed as H₂O or CO, per the above recited HDO and DCO reaction pathways. As an example, for phenol the oxygen is removed directly thus producing benzene and H₂O. The oxygen in phenol can also be removed via a hydrogenation pathway, where phenol is first converted to cyclohexanol and then to cyclohexane and H₂O.

Remaining alcohols and acids or other compounds having carbonyl groups from the stabilization would then be converted to paraffins in the subsequent HDO stage, per the recited reaction HDO and DCO pathways.

The material catalytically active in hydrotreating, e.g. HDO, typically comprises an active metal (sulfided base metals such as nickel, cobalt, tungsten and/or molybdenum, but possibly also either elemental noble metals such as platinum and/or palladium) and a refractory support (such as alumina, silica or titania, or combinations thereof).

This hydrotreating, herein referred to as HDO conditions, involves a temperature in the interval 250-400° C., such as 300-400° C., a pressure in the interval 30-250 bar, such as 50-150 bar, and a liquid hourly space velocity (LHSV) in the interval 0.1-2, optionally together with intermediate cooling by quenching with cold hydrogen, feed or product.

The material catalytically active in hydrodewaxing, herein interchangeably used with the term hydroisomerization or simply isomerization, typically comprises an active metal (either elemental noble metals such as platinum and/or palladium or sulfided base metals such as nickel, cobalt, tungsten and/or molybdenum), an acidic support (typically a molecular sieve showing high shape selectivity, and having a topology such as MOR, FER, MRE, MWW, AEL, TON and MTT) and a refractory support (such as alumina, silica or titania, or combinations thereof).

Isomerization conditions involve a temperature in the interval 250-400° C., a pressure in the interval 20-100 bar, and a liquid hourly space velocity (LHSV) in the interval 0.5-8.

The material catalytically active in hydrocracking is of similar nature to the material catalytically active in isomerization, and it typically comprises an active metal (either elemental noble metals such as platinum and/or palladium or sulfided base metals such as nickel, cobalt, tungsten and/or molybdenum), an acidic support (typically a molecular sieve showing high cracking activity, and having a topology such as MFI, BEA and FAU) and a refractory support (such as alumina, silica or titania, or combinations thereof). The difference to material catalytically active isomerization is typically the nature of the acidic support, which may be of a different structure (even amorphous silica-alumina) or have a different acidity e.g. due to silica:alumina ratio.

Hydrocracking conditions involve a temperature in the interval 250-400° C., a pressure in the interval 30-150 bar, and a liquid hourly space velocity (LHSV) in the interval 0.5-8, optionally together with intermediate cooling by quenching with cold hydrogen, feed or product Other types of hydrotreating are also envisaged, for instance hydrodearomatization (HDA).

The material catalytically active in hydrodearomatization typically comprises an active metal (typically elemental noble metals such as platinum and/or palladium but possibly also sulfided base metals such as nickel, cobalt, tungsten and/or molybdenum) and a refractory support (such as amorphous silica-alumina, alumina, silica or titania, or combinations thereof).

Hydrodearomatization conditions involve a temperature in the interval 200-350° C., a pressure in the interval 20-100 bar, and a liquid hourly space velocity (LHSV) in the interval 0.5-8.

In an embodiment, as recited in appended claim 13, the process further comprises passing the stabilized liquid oil stream through one or more metal guards active in hydrometallation (HDM) and/or hydrodeoxygenation (HDO), prior to said HDO step.

Thereby, a purified hydtrotreated effluent stream is produced prior to feeding it to the subsequent HDO step. The term “metal guard bed active in HDM and/or HDO” is also referred herein simply as “metal guard bed”, and means a bed, i.e. a fixed bed, which comprises a material active in HDM and/or HDO, such as catalyst active in HDM and/or HDO, so that apart from for removing e.g. phosphorous (P), iron (Fe), nickel (Ni), or vanadium (V), silicon (Si), halides, or combinations thereof, the material may also be provided with deoxygenation activity. A suitably guard bed for at least removing P and Fe is a porous material comprising alumina, the alumina comprising alpha-alumina, with the porous material comprising one or more metals selected from Co, Mo, Ni, W and combinations thereof, and said porous material having a BET-surface area of 1-110 m²/g, suitably also having a total pore volume of 0.50-0.80 ml/g, as measured by mercury intrusion porosimetry, and a pore size distribution (PSD) with at least 30 vol % of the total pore volume being in pores with a radius≥400 Å, suitably pores with a radius≥500 Å, such as pores with a radius up to 5000 Å; as for instance disclosed in Applicant's patent application WO 2022008508. Another suitably guard bed is a catalyst comprising molybdenum supported on alumina, i.e. a Mo/Al₂O₃ catalyst. Yet another suitably catalyst is a catalyst having demetallization activity and moderate hydrodesulfurization activity, such as a commercial TK-743 catalyst.

Hydrodemetallation (HDM), as is well known in the art, means a pretreatment, by which free metals are generated and then reacted with e.g. H₂S into metal sulfides. It would be understood that this is different from e.g. hydrodesulfurization (HDS) in which the heteroatom (S) is removed in gas form.

In an embodiment, as recited in appended claim 14, the process further comprises:
providing a make-up hydrogen gas and supplying at least a portion thereof as said hydrogen for forming said stabilized liquid oil stream; and/or
providing a recycle gas comprising CO and supplying at least a portion thereof, thus a portion of the recycle gas comprising CO, to the stabilized liquid oil stream prior to said HDO step, i.e. to a point downstream said stabilization but upstream said HDO, such as prior to passing the stabilized liquid oil stream through the one or more metal guards active in hydrometallation (HDM) and/or hydrodeoxygenation (HDO).

It is normally desirable to introduce a make-up hydrogen gas to the stabilization reactor, such as hydrogen produced internally in the plant or hydrogen sourced externally i.e. from outside the battery limits of the plant, or a combination thereof. Along with the make-up hydrogen gas, it is normally also desirable to introduce a recycle gas to the stabilization reactor. The recycle gas is for instance a hydrogen-rich gas produced in the process or plant, or a light hydrocarbon stream comprising C1-C4 hydrocarbons, or an off-gas stream comprising carbon oxides (CO₂, CO), H₂O, H₂ and C1-C4 hydrocarbons. Common for any of these recycle gases is the presence of CO, albeit in low concentrations.

It has been found that the use of reduced nickel catalyst in connection with some liquid oil streams being fed to the stabilization step, conveys the problem of the nickel being removed as Ni(CO)₄ (nickel carbonyl) when there is CO in the gas. Nickel carbonyl is undesired as it is highly toxic and can be fatal if inhaled; it can cause severe skin burns and eye damage, as well as being a flammable liquid and vapor. Thus, by the invention, the sending a recycle gas and which normally comprises at least some CO to the stabilization reactor, as is routine in the art, is omitted. The make-up H₂, which is free of CO, is sent to the stabilization reactor(s) while the recycle gas is added downstream the stabilization reactor and upstream the HDO reactor. The safety of the process and plant is thereby increased.

In an embodiment, the process further comprises: prior to said stabilization for forming a stabilized liquid oil stream, passing the liquid oil stream to a purification step for removing impurities in said liquid oil stream. For instance, a liquid oil stream being provided as a waste plastic pyrolysis oil may contain at least 10 ppm wt Cl, which results from the imperfect sorting of PVC products. The removal of this impurity (Cl) from the liquid oil stream is then necessary or may become necessary.

In an embodiment, the process further comprises, prior to said stabilization for forming a stabilized liquid oil stream, diluting the liquid oil stream with an organic diluent.

In another general embodiment according to the first aspect of the invention, there is provided a process for hydrotreating a liquid oil stream, said liquid oil stream containing 30-50 wt % O, by in a continuous operation in a fixed bed reactor, reacting the liquid oil stream with hydrogen in the presence of a reduced nickel (Ni) catalyst, at a temperature in the range 80-225° C., such as 100-225° C.; a pressure of 120-200 barg, such as 125-175 barg; a liquid hourly space velocity (LHSV) of 0.1-1.0 h⁻¹, such as 0.2-0.6 h⁻¹; a hydrogen to liquid oil ratio of 1500-3500 NL/L such as 2000-3000 NL/L, thereby forming a stabilized liquid oil stream; wherein the reduced Ni catalyst is a supported catalyst having a Ni content of 2-30 wt %, such as 5-25 wt %, based on the total weight of the catalyst; and the support is selected from any of: alumina (Al₂O₃), alumina magnesium spinel (MgAl₂O₄), and combinations thereof; optionally in combination with a molecular sieve having topology MFI, BEA or FAU; and wherein said alumina is any of:
alumina comprising 90-100 wt % gamma alumina; as well as having: a BET surface area of 230-250 m²/g, a total pore volume (PV) of 800-900 mL/kg as measured by mercury intrusion porosimetry;
alumina comprising 90-100 wt % gamma alumina; as well as having: a BET surface area of 165-185 m²/g, a total pore volume (PV) of 950-1100 mL/kg as measured by mercury intrusion porosimetry;
alumina comprising 80-100 wt % theta alumina and 0-20 wt % alpha alumina; as well as having: a BET surface area of 50-60 m²/g, a total pore volume (PV) of 600-700 mL/kg as measured by mercury intrusion porosimetry.

This process is thus particularly advantageous for highly reactive pyrolysis oils. At these process conditions, breaking of C═0 bonds in the liquid oil is further ensured. Furthermore, as already explained, the particular range of hydrogen to liquid oil ratio has the associated benefit of hydrogen starvation being avoided as well as pushing the reaction rate and/or equilibrium.

Any of the embodiments and associated benefits of the first aspect of the invention corresponding to highly reactive liquid oils containing 30-50 wt % O may be used in connection with this general embodiment (“another general embodiment”).

In yet another general embodiment according to the first aspect of the invention, there is provided a process for hydrotreating a liquid oil stream, said liquid oil stream containing 0.05-15 wt % O, by in a continuous operation in a fixed bed reactor, reacting the liquid oil stream with hydrogen in the presence of a reduced nickel (Ni) catalyst, at a temperature in the range 80-225° C., such as 100-200° C.; a pressure of 40-180 barg, such as 40-60 barg or 70-180 barg; a liquid hourly space velocity (LHSV) of 1-3 h⁻¹, such as 1.5-2.5 h⁻¹; a hydrogen to liquid oil ratio of 400-700 NL/L such as 500-600 NL/L, thereby forming a stabilized liquid oil stream; wherein the reduced Ni catalyst is a supported catalyst having a Ni content of 2-30 wt %, such as 5-25 wt %, based on the total weight of the catalyst; and the support is selected from any of: alumina (Al₂O₃), alumina magnesium spinel (MgAl₂O₄), and combinations thereof; optionally in combination with a molecular sieve having topology MFI, BEA or FAU; and wherein said alumina is any of:
alumina comprising 90-100 wt % gamma alumina; as well as having: a BET surface area of 230-250 m²/g, a total pore volume (PV) of 800-900 mL/kg as measured by mercury intrusion porosimetry;
alumina comprising 90-100 wt % gamma alumina; as well as having: a BET surface area of 165-185 m²/g, a total pore volume (PV) of 950-1100 mL/kg as measured by mercury intrusion porosimetry;
alumina comprising 80-100 wt % theta alumina and 0-20 wt % alpha alumina; as well as having: a BET surface area of 50-60 m²/g, a total pore volume (PV) of 600-700 mL/kg as measured by mercury intrusion porosimetry.

This process is thus particularly advantageous for less reactive HTL oils, waste plastic pyrolysis oils or waste tyres pyrolysis oils. At these process conditions, breaking of C═C bonds in the liquid oil is further ensured. The breakage of C═C bonds via the use of a reduced nickel catalyst in accordance with the present invention, as exemplified by the conversion of styrene to ethylbenzene, is significantly higher than when a NiMo-based catalyst is used. Furthermore, as already explained, the particular range of hydrogen to liquid oil ratio has the associated benefit of hydrogen starvation being avoided.

Any of the embodiments and associated benefits of the first aspect of the invention corresponding to less reactive liquid oils containing 0.05-15 wt % O may be used in connection with this general embodiment (“yet another general embodiment”).

In a second aspect, the invention encompasses also a plant for carrying out the process according to any of the above embodiments.

Accordingly, as recited in appended claim 15, there is provided a plant for carrying out the process according to any of the above process embodiments, comprising:
a stabilization reactor arranged as a fixed bed reactor and for continuous operation, the stabilization reactor further being arranged to receive a liquid oil stream and reacting the liquid oil stream with hydrogen in the presence of a reduced nickel (Ni) catalyst at a temperature of 80-250° C., a pressure of 10-200 barg, a liquid hourly space velocity (LHSV) of 0.1-6.0 h⁻¹, and a hydrogen to liquid oil ratio, defined as the volume ratio of hydrogen to the flow of the liquid oil stream, of 100-8000 NL/L; the stabilization reactor further being arranged to provide an outlet comprising a stabilized liquid oil stream; wherein the reduced Ni catalyst is a supported catalyst having a Ni content of 2-30 wt %, such as 5-25 wt %, based on the total weight of the catalyst; and the support is selected from any of: alumina (Al₂O₃), alumina magnesium spinel (MgAl₂O₄), and combinations thereof; optionally in combination with a molecular sieve having topology MFI, BEA or FAU; and wherein said alumina is any of:
alumina comprising 90-100 wt % gamma alumina; as well as having:
   a BET surface area of 230-250 m²/g,
   a total pore volume (PV) of 800-900 mL/kg as measured by mercury intrusion porosimetry;
alumina comprising 90-100 wt % gamma alumina; as well as having:
   a BET surface area of 165-185 m²/g,
   a total pore volume (PV) of 950-1100 mL/kg as measured by mercury intrusion porosimetry;
alumina comprising 80-100 wt % theta alumina and 0-20 wt % alpha alumina; as well as having:
   a BET surface area of 50-60 m²/g,
   a total pore volume (PV) of 600-700 mL/kg as measured by mercury intrusion porosimetry.

Any of the embodiments and associated benefits of the first aspect of the invention (process) may be used in connection with the second aspect of the invention (plant) or vice versa.

The invention provides a superior process and plant for the stabilization of liquid oils.

Advantages of the invention include:
A flexible process for the conversion of third generation renewable feedstocks into hydrocarbon products boiling in the transportation fuel range, in particular any of diesel, jet fuel as sustainable aviation fuel and naphtha. A wide range of liquid oils, i.e. liquid oils comprising a wide range of oxygen content, are stabilized prior to subsequent HDO and any further treatment for producing said transportation fuels, as well as hydrocarbon feeds such as naphtha, ethane, propane or butane, for steam crackers for polymer production.
At least for liquid oils of low oxygen content (0.05-15 wt % O): a much higher conversion of styrene to ethylbenzene compared to when stabilizing with a NiMo-based catalyst.
At least for liquid oils of high oxygen content (30-50 wt % O): lower density values obtained when using reduced nickel catalysts (monometallic nickel catalysts) and alumina support with medium surface area and high pore volume; improved results compared to NiMo-based catalyst also in term of lower carbonyl numbers in all stabilized samples prepared with respect to liquid oil feed.

FIG. 1 shows the density change with time on stream during the stabilization of a pyrolysis oil with different catalysts in accordance with Example 2.

FIG. 2 shows the carbonyl number of the pyrolysis oil feed and the stabilized pyrolysis oil with different catalysts in accordance with Example 2.

### EXAMPLES

### Example 1: Styrene Hydrogenation of Less Reactive Liquid Oil

Example 1, which is according to an embodiment of the present invention, involves the reaction of a model feed of liquid oil representing a less reactive liquid oil. Two diluted feeds were provided:

### Feed 1:

6/94 (6 wt % plastic pyrolysis oil; 94 wt % white spirits: CAS nr. 64742-82-1) oil containing 0.08 wt % oxygen (O); 1.3 wt % styrene.

### Feed 2:

12/88 (12 wt % plastic pyrolysis oil; 88 wt % white spirits: CAS nr. 64742-82-1) oil containing 0.16 wt % oxygen (O); 2.4 wt % styrene.

Reduced Ni catalyst: catalyst D-high Ni in Table 3—Example 2; and surface passivated with S supported on gamma alumina.

NiMo catalyst: traditional NiMo formulation, sulfided NiMo: Ni content: ^{~}3 wt % based on total catalyst weight, Mo content: ^{~}13 wt % based on total catalyst weight. Support: gamma alumina, high surface area (as carrier A, Table 3—Example 2).

Tests were conducted in a fixed bed reactor comprising the reduced nickel catalyst (pre-reduced) or NiMo catalyst at pressure of 50 bar, temperature of 100-125° C. (inlet/feed temperature); liquid hour space velocity (LHSV) of 2 h⁻¹ and H₂/oil ratio of 500 NL/L.

These test conditions were used for comparing the styrene hydrogenation performance of the reduced Ni and NiMo catalysts. The main results which were apparent in the distillation curves (not shown) of the product samples, where plateaus at 147° C. (styrene) and 137° C. (ethylbenzene) were visible. Table 1 below shows the performance in terms of conversions estimated from either GC-VUV analysis of the product (the case for the NiMo catalyst tests), or by visual inspection of the distillation curves for the Ni catalyst.

TABLE 1
Styrene conversion

| Liquid oil | Feed 1 | Feed 1 | Feed 2 | Feed 2 |
|---|---|---|---|---|
| Inlet temperature (° C.) | 100 | 125 | 100 | 125 |
| Conversion over | 12% | 65% | 0% | 13% |
| NiMo-catalyst | | | | |
| (comparative) | | | | |
| Conversion over Ni- | 85% | 90% | n.a. | 70% |
| catalyst | | | | |
| (invention) | | | | |

n.a.: not available

The styrene conversion, as a proxy of stabilization, is significantly higher when conducting the stabilization with reduced nickel catalyst according to the invention compared to traditional NiMo formulation.

### Example 2: Density and Carbonyl Number Reduction of Highly Reactive Liquid Oil

Example 2 which is according to an embodiment of the present invention, involves reaction of a highly reactive liquid oil, more specifically a highly reactive pyrolysis oil, containing near 50 wt % oxygen, per below Table 2.

TABLE 2
Composition of liquid oil

| Analysis | | |
|---|---|---|
| Density at 40° C. | 1.1891 | g/mL |
| Density at 15° C. | 1.2119 | g/mL |
| Hydrogen (H) | 7.4. | wt % |
| Carbon (C) | 44.05 | wt % |
| Oxygen (O) | 48.54 | wt % |
| Water dissolved | 21.44 | v/v % |
| Carbon residue | 18.81 | wt % |

Tests were performed on a reduced Ni catalyst i.e. monometallic catalyst (Ni), on different supports (A, B, C, D—per below Table 3), namely alumina (Al₂O₃) and magnesium aluminium spinel (MgAl₂O₄). On one alumina support (D), tests were performed with a high nickel content (about 22 wt % Ni) and low nickel content (about 13 wt % Ni). Tests were also performed with a NiMo-based catalyst on support A. The metal contents are based on the total weight of the catalyst, thus including the support:

TABLE 3
Catalysts for stabilization

| | | | | BET | |
|---|---|---|---|---|---|
| | | | Metal | Surface | Total Pore |
| | | | content, | Area, | Volume (PV), |
| Sample | Support | Metal | wt % | m²/g | ml/kg |
| A | Gamma | Ni | 11.4 | 244 | 886 |
| (invention) | alumina | | | | |
| B | 80% theta | Ni | 8.55 | 57 | 651 |
| (invention) | alumina, | | | | |
| | 20% alpha | | | | |
| | alumina | | | | |
| C | MgAl₂O₄ | Ni | 10.5 | 185 | 944 |
| (invention) | | | | | |
| D-low Ni | Gamma | Ni | 12.9 | 175 | 1058 |
| (invention) | alumina | | | | |
| D-high Ni | Gamma | Ni | 22.1 | 175 | 1058 |
| (invention) | alumina | | | | |
| A | Gamma | NiMo | Ni: 3.6 | 244 | 886 |
| (comparative) | alumina | | Mo: 20.3 | | |

For determination of total pore volume and pore size distribution, mercury intrusion porosimetry is conducted according to ASTM D4284. The BET-surface area is measured according to ASTM D4567-19, i.e. single-point determination of surface area by the BET equation. The content of alpha alumina, theta alumina, gamma alumina is as determined by XRD (X-ray diffraction). More specifically, XRD for determination of e.g. alumina phases: samples are rinsed by extraction with xylene, dried in vacuum and analysed for metals/P capture (XRF, X-ray fluorescence analysis according to EN ISO 12677:2011), SEM, Carbon and Sulphur (C+S; LECO analysis, ASTM E1915-13) and BET-surface area (ASTM D4567-19).

Tests were conducted with at duration of about 10 days in a fixed bed reactor comprising the reduced nickel catalyst (pre-reduced) and NiMo catalyst of Table 3 at pressure of 135 bar, temperatures of 80-220° C. with inlet/feed temperature of 80° C.; LHSV=0.2 h⁻¹ and H₂/oil ratio=2500 NL/L.

FIG. 1 shows the density change (Y-axis; specific gravity (SG)) of the liquid oil with respect to the liquid oil feed at time on stream, (X-axis; TOS=0 h), and FIG. 2 shows the carbonyl number of the feed (left bar column) compared with the stabilized liquid oils in accordance with the samples of Table 3. The carbonyl number (carbonyl no) of the stabilized liquid oil stream is measured by ASTM E 3146.

Lower density values with respect to the liquid oil feed are obtained which are at least on par with the NiMo catalyst (sample A—comparative) when using the monometallic Ni catalyst. The monometallic Ni catalyst comprising an alumina support with medium surface area and high pore volume (samples D-low Ni, D-high Ni), as depicted in the lower lines of FIG. 1, show improved performance with respect to the NiMo catalyst. Further, per FIG. 2, there are lower carbonyl numbers in all samples prepared, compared to liquid oil feed, showing that significant stabilization of the liquid oil is achieved. Moreover, apart from improved performance in terms of lowering the density of the liquid oil feed, samples D-low Ni (“Carrier D low metal”) and D-high Ni (“Carrier D high metal”), particularly the former, shows the lowest carbonyl number and thereby highest carbonyl number ratio. Therefore, for this supported catalyst (D-low Ni i.e. “Carrier D low metal”), there is a superior stabilization performance not only in terms of lower stable density (low density of liquid oil maintained with time on stream), but also in terms of lower carbonyl numbers.

1. A process for hydrotreating a liquid oil stream by, in a continuous operation in a fixed bed reactor, reacting the liquid oil stream with hydrogen in the presence of a reduced nickel (Ni) catalyst at a temperature of 80-250° C., a pressure of 10-200 barg, a liquid hourly space velocity (LHSV) of 0.1-6.0 h⁻¹, and a hydrogen to liquid oil ratio, defined as the volume ratio of hydrogen to the flow of the liquid oil stream, of 100-8000 NL/L, thereby forming a stabilized liquid oil stream;
wherein the reduced Ni catalyst is a supported catalyst having a Ni content of 2-30 wt %, based on the total weight of the catalyst;
wherein the support is selected from any of: alumina (Al₂O₃), alumina magnesium spinel (MgAl₂O₄), and combinations thereof; optionally in combination with a molecular sieve having topology MFI, BEA or FAU; and
wherein said alumina is any of:
alumina comprising 90-100 wt % gamma alumina; as well as having: a BET surface area of 230-250 m²/g, a total pore volume (PV) of 800-900 mL/kg as measured by mercury intrusion porosimetry;
alumina comprising 90-100 wt % gamma alumina; as well as having: a BET surface area of 165-185 m²/g, a total pore volume (PV) of 950-1100 mL/kg as measured by mercury intrusion porosimetry;
alumina comprising 80-100 wt % theta alumina and 0-20 wt % alpha alumina; as well as having: a BET surface area of 50-60 m²/g, a total pore volume (PV) of 600-700 mL/kg as measured by mercury intrusion porosimetry.

2. Process according to claim 1, wherein the Ni content is 10-15 wt % and the alumina is said alumina comprising 90-100 wt % gamma alumina, as well as having: a BET surface area of 165-185 m²/g, and a total pore volume (PV) of 950-1100 mL/kg as measured by mercury intrusion porosimetry.

3. Process according to claim 1, wherein the liquid oil stream contains at least 0.05 wt % oxygen (O).

4. Process according to claim 1, wherein the ratio of the carbonyl number as measured by ASTM E 3146 in mol/kg of the liquid oil stream with respect to the stabilized liquid oil stream is 1.7 or higher.

5. Process according to claim 4, wherein the carbonyl number of the stabilized liquid oil stream is below 3.0 mol/kg, as measured by ASTM E 3146.

6. Process according to claim 1, wherein the temperature is in the range 80-225° C.; the pressure is 120-200 barg; LHSV is 0.1-1.0 h⁻¹; the hydrogen to liquid oil ratio is 1500-3500 NL/L, and the liquid oil stream contains 30-50 wt % O.

7. Process according to claim 1, wherein the temperature is in the range 80-225° C.; the pressure is 40-180 barg; LHSV is 1-3 h⁻¹; the hydrogen to liquid oil ratio is 400-700 NL/L, and the liquid oil stream contains 0.05-15 wt % O.

8. Process according to claim 7, wherein the content of sulfur (S) in said liquid oil stream containing 0.05-15 wt % O is below 100 ppm wt.

9. Process according to claim 1, further comprising a prior step of thermal decomposition of a solid renewable feedstock, for producing said liquid oil stream;
wherein said liquid oil stream is a pyrolysis oil stream or a hydrothermal liquefaction oil (HTL oil) stream; and
wherein the thermal decomposition step is:
pyrolysis, thereby producing said pyrolysis oil stream; or
hydrothermal liquefaction, thereby producing said HTL oil stream.

10. Process according to claim 9, wherein the pyrolysis is fast pyrolysis, said fast pyrolysis suitably being conducted without the presence of a catalyst and hydrogen.

11. Process according to claim 9, wherein the solid renewable feedstock is any of:
a lignocellulosic biomass including: wood products, forestry waste, and agricultural residue;
sewage sludge;
waste tires;
municipal waste;
a feedstock of plastic or polymeric origin including a mixed or sorted waste comprising at least 50 wt % plastic and other synthetic polymers;
combinations thereof.

12. Process according to claim 1, further comprising passing the stabilized liquid oil stream through a hydrodeoxygenation (HDO) step.

13. Process according to claim 12, further comprising passing the stabilized liquid oil stream through one or more metal guards active in hydrometallation (HDM) and/or hydrodeoxygenation (HDO), prior to said HDO step.

14. Process according to claim 12, further comprising:
providing a make-up hydrogen gas and supplying at least a portion thereof as said hydrogen for forming said stabilized liquid oil stream; and/or
providing a recycle gas comprising CO and supplying at least a portion thereof to the stabilized liquid oil stream prior to said HDO step.

15. Plant for carrying out the process according to claim 1, comprising:
a stabilization reactor arranged as a fixed bed reactor and for continuous operation, the stabilization reactor further being arranged to receive a liquid oil stream and reacting the liquid oil stream with hydrogen in the presence of a reduced nickel (Ni) catalyst at a temperature of 80-250° C., a pressure of 10-200 barg, a liquid hourly space velocity (LHSV) of 0.1-6.0 h⁻¹, and a hydrogen to liquid oil ratio, defined as the volume ratio of hydrogen to the flow of the liquid oil stream, of 100-8000 NL/L; the stabilization reactor further being arranged to provide an outlet comprising a stabilized liquid oil stream; wherein the reduced Ni catalyst is a supported catalyst having a Ni content of 2-30 wt %, based on the total weight of the catalyst; and the support is selected from any of: alumina (Al₂O₃), alumina magnesium spinel (MgAl₂O₄), and combinations thereof; optionally in combination with a molecular sieve having topology MFI, BEA or FAU; and wherein said alumina is any of:
alumina comprising 90-100 wt % gamma alumina; as well as having: a BET surface area of 230-250 m²/g, a total pore volume (PV) of 800-900 mL/kg as measured by mercury intrusion porosimetry;
alumina comprising 90-100 wt % gamma alumina; as well as having: a BET surface area of 165-185 m²/g, a total pore volume (PV) of 950-1100 mL/kg as measured by mercury intrusion porosimetry;
alumina comprising 80-100 wt % theta alumina and 0-20 wt % alpha alumina; as well as having: a BET surface area of 50-60 m²/g, a total pore volume (PV) of 600-700 mL/kg as measured by mercury intrusion porosimetry.
